(19) United States
(12) Patent Application Publication
(10) Pub. No.: US 2002/0008058 A1
(43) Pub. Date: Jan. 24, 2002

(54) TAPERED BORE COLUMN FOR HIGH PERFORMANCE LIQUID CHROMATOGRAPHY

(76) Inventor: KERRY D. NUGENT, AUBURN, CA (US)

Correspondence Address: BRADLEY P HEISLER, HEISLER AND ASSOCIATES, 3017 DOUGLAS BOULEVARD SUITE 300, ROSEVILLE, CA, 95661

(21) Appl. No.: 09/324,684

(22) Filed: Jun. 3, 1999

(51) Int. Cl. B01D 15/00

(52) U.S. Cl. 210/198.2; 436/161

(57) ABSTRACT

A column 20 is provided for use in high performance liquid chromatography systems. The column 20 has a bore 50 passing therethrough with an inlet 52 larger than an outlet 54. The side wall 56 of the bore 50 tapers as it extends between the inlet 52 and the outlet 54. The tapering bore 50 is packed with a chromatographic separation medium held within the tapering bore 50 by an inlet frit 38 adjacent an inlet 52 and an outlet frit 48 adjacent the outlet 54. The tapered bore column 20 can be substituted for standard cylindrical bore columns within high performance liquid chromatography systems to increase sample component resolution per unit time.

### FIELD OF THE INVENTION

The following invention relates to analytical high performance liquid chromatography where components of a sample are chromatographically separated before analytically determining the nature of the components of the sample. More particularly, this invention relates to columns for use in analytical high performance liquid chromatography systems which are configured to rapidly and precisely separate components of a sample to be analyzed.

### BACKGROUND OF THE INVENTION

Liquid chromatography (LC) has been in use for nearly a century, for separation of a wide range of inorganic, organic and biological chemicals. Classical LC used large bore (10-50 mm ID) glass columns packed with large particle supports (silica gel, polymeric beads, etc.) using gravity flow to elute samples slowly (hours to days) from the column. LC can separate chemicals based on a wide variety of physical and chemical properties including size, charge and polarity.

High performance liquid chromatography (HPLC) was developed over thirty years ago, by packing smaller, more uniform particles in metal columns of constant bore (2-5 mm ID) and using high pressure pumps to flow liquids through the column. HPLC resulted in faster (minutes to hours), higher resolution separations. In the past decade, improvements in HPLC columns have included the use of more inert column tubes (316 stainless steel, glass-lined stainless steel, fused silica and solvent resistant high-pressure plastics).

Known prior art LC and HPLC columns have been packed in cylindrical tubes of consistent ID (same ID at the inlet and outlet of the column). HPLC columns are available in ID's from 0.05-50₁ mm. Conventional HPLC separations for analytical applications use tubular columns with ID's from 2-5 mm and lengths from 30-300 mm. Separations are usually run at an optimum linear velocity (˜5 cm/min) using a constant mobile phase (isocratic elution) or a continuously changing mobile phase (gradient elution) with total run times from 5-120 minutes, depending on the complexity of the samples being analyzed. Analytical HPLC accounts for over 90% of the use of HPLC, while more specialized techniques such as preparative HPLC for purification of large amounts of various chemicals of interest (columns with ID's from 10-50+ mm) and micro/capillary HPLC for trace level isolation and identification of various chemicals of interest (columns with ID's from 0.05-1.0 mm) make up the majority of the remaining uses of HPLC.

Although there are several different modes of HPLC (size exclusion, ion exchange, normal phase, reversed phase, etc.), reversed phase HPLC is used in over 90% of the analytical HPLC methods currently in use. In reversed phase HPLC, the stationary phase (bonded to a silica or polymeric packing) is non-polar and the mobile phase (pumped under high pressure through the column) is polar. Reversed phase HPLC was named because the initial mode of liquid chromatography (normal phase) used a polar stationary phase and a non-polar mobile phase.

The major area of application of HPLC is in the pharmaceutical industry. Over the past ten years, pharmaceutical companies have been developing techniques to synthesize greater numbers of chemicals in the continuing search for new pharmaceuticals to improve human health care and promote longer, healthier human life spans. This has resulted in the rapid growth of a new field called combinatorial chemistry, where a single chemist can design and automate the synthesis of hundreds to thousands of compounds per day (compared with an average of hundreds per chemist per year a decade ago). Paralleling the development of combinatorial chemistry has been the development of two related biochemical fields: 1) genomics—the characterization of the entire genetic make-up (DNA) of humans and other living organisms and 2) proteomics—the characterization of human proteins that are the key targets for pharmaceuticals that can help to cure various human diseases (Cancer, AIDS, Alzheimer's, Multiple Sclerosis, etc.). All three of these fields have put a huge demand on analytical chemists who are required to separate, purify, analyze, quantitate and characterize these vast arrays of chemicals and biochemicals with a range of techniques including HPLC.

Accordingly, a need exists for systems and devices which can more rapidly perform high pressure liquid chromatography, while maintaining the necessary accuracy. With this invention, a column is provided which can be used with existing high pressure liquid chromatography equipment and which can increase by five times or more the speed with which chromatographic separation of components of a sample can occur.

The column of this invention has a bore which tapers from a larger diameter to a smaller diameter to achieve highly accurate, more rapid chromatographic separation of sample components. Prior art columns and related fluid handling devices are known which include tapering profiles and/or outlets larger than inlets. Such prior art devices are described in detail in the following patents:

| Inventor | Patent Number |
|---|---|
| Dalton | 3,492,396 |
| Fraser | 3,771,659 |
| Eisenbeiss | 3,791,522 |
| Randau | 3,855,130 |
| Hara | 4,289,620 |
| Golias | 4,341,635 |
| Ruijten | 4,554,071 |
| Shalon | 4,719,011 |
| Donald | 4,787,971 |

However, these prior art devices are not applicable in analytical HPLC systems. Either they are low pressure separation devices unrelated to HPLC or they are large volume preparative HPLC devices.

### SUMMARY OF THE INVENTION

This invention provides an improved column for use in analytical high performance liquid chromatography systems. Rather than having a constant diameter cylindrical bore passing through the column, the column of this invention has a bore with a side wall which tapers. Specifically, the bore includes an inlet which is larger than the outlet and which has a tapering side wall defining the bore passing through the column. Tapering of the bore has been shown to accelerate chromatographic separation of components of the sample which passes through the bore. Tapering of the bore has also been shown to axially concentrate the individual sample components, resulting in enhanced resolution and sensitivity. The bore is packed with a chromatography separation medium which is appropriate for any one of the high pressure liquid chromatography separation modes, such as size exclusion, ion exchange, normal phase, reversed phase, etc.

The column preferably includes frits at ends thereof that retain the separation medium within the bore. The resulting packed bore column and frit cartridge can be easily placed into a holder for location within a high performance liquid chromatography system between a sample injector and a component detector. According to this invention, the column can take on many different forms, so long as the bore within the column tapers from a larger size at the inlet to a smaller size at the outlet, either with a constant rate of taper or with various other non-constant tapering configurations.

### OBJECTS OF THE INVENTION

Accordingly, a primary object of the present invention is to provide a column for high performance liquid chromatography (HPLC) which provides faster analysis times than a standard cylindrical bore HPLC column with a similar inlet inner diameter.

Another object of the present invention is to provide a HPLC column which provides better sensitivity than an analogous standard bore HPLC column.

Another object of the present invention is to provide a HPLC column which provides a lower back pressure than a standard bore HPLC column at a common linear velocity.

Another object of the present invention is to provide a tapered bore HPLC column which has a similar sample capacity as a standard bore HPLC column.

Another object of the present invention is to provide a tapered bore HPLC column which provides lower back pressure than a standard bore HPLC column at a common flow rate.

Another object of the present invention is to provide a tapered bore HPLC column which provides a higher sample capacity than a standard bore HPLC column having an inner diameter equal to an outlet inner diameter of the tapered bore column of this invention.

Another object of the present invention is to provide a HPLC column which can achieve higher throughput than a standard bore HPLC column.

Another object of the present invention is to provide a higher sensitivity HPLC column than a standard cylindrical bore HPLC column.

Another object of the present invention is to provide a tapered bore HPLC column which can fit within existing HPLC equipment without significant modification of such equipment.

Another object of the present invention is to provide a HPLC column which can be formed from injection molded plastic materials and withstand pressures in excess of 5,000 psi.

Other further objects of the present invention will become apparent from a careful reading of the included drawing figures, the claims and detailed description of the invention.

### BRIEF DESCRIPTION OF THE DRAWINGS

FIG. 1 is a full section view of a holder and column assembly similar to that which would be inserted into an analytical HPLC system between a sample injector and a component detector.

FIG. 2 is a perspective view of the column of this invention.

FIG. 3 is a full section view of that which is shown in FIG. 2 revealing the tapering bore passing therethrough and the frits located adjacent the inlet and the outlet of the bore.

FIG. 4 is a left end view of that which is shown in FIG. 2.

FIG. 5 is a right end view of that which is shown in FIG. 2.

FIG. 6 is a block diagram revealing how the column of this invention is interposed between a sample injector and a component detector as part of an overall analytical high pressure liquid chromatography system.

FIG. 7 is a graph depicting detection of peaks for different components within a sample over time at a given flow rate and pressure using the tapered bore HPLC column of this invention.

FIG. 8 is a graph analogous to that which is shown in FIG. 7 but utilizing a standard bore HPLC column having an inner diameter matching the inlet diameter of the tapered bore HPLC column of this invention at a similar flow rate, revealing how a significantly greater amount of time is required to achieve a similar amount of component detection resolution when compared to the tapered bore HPLC column of this invention.

FIG. 9 is a graph similar to that which is shown in FIGS. 7 and 8 but representing a higher pressure higher flow rate standard bore HPLC column which exhibits decreased resolution and sensitivity when compared to the detection resolution shown in FIG. 7 for the tapered bore HPLC column when given a similar amount of time.

FIG. 10 is a graph depicting five different gradient elution assays utilizing the tapered bore HPLC column of this invention and revealing how satisfactory separation resolution is achieved after approximately one minute as opposed to the three to six minutes required for similar gradient elution procedures utilizing a standard bore HPLC column.

### DESCRIPTION OF THE PREFERRED EMBODIMENT

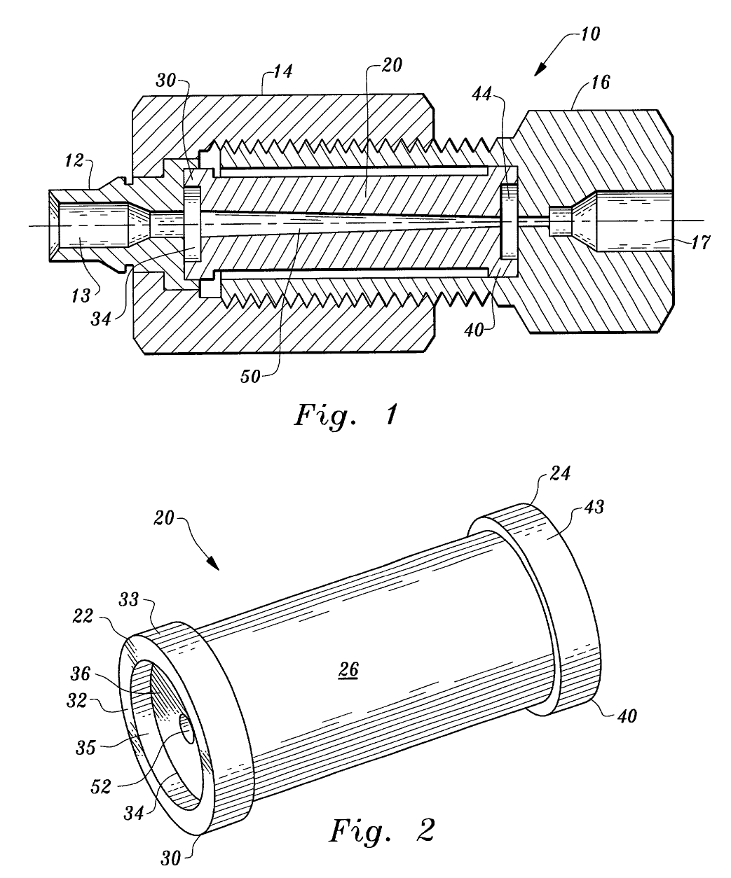

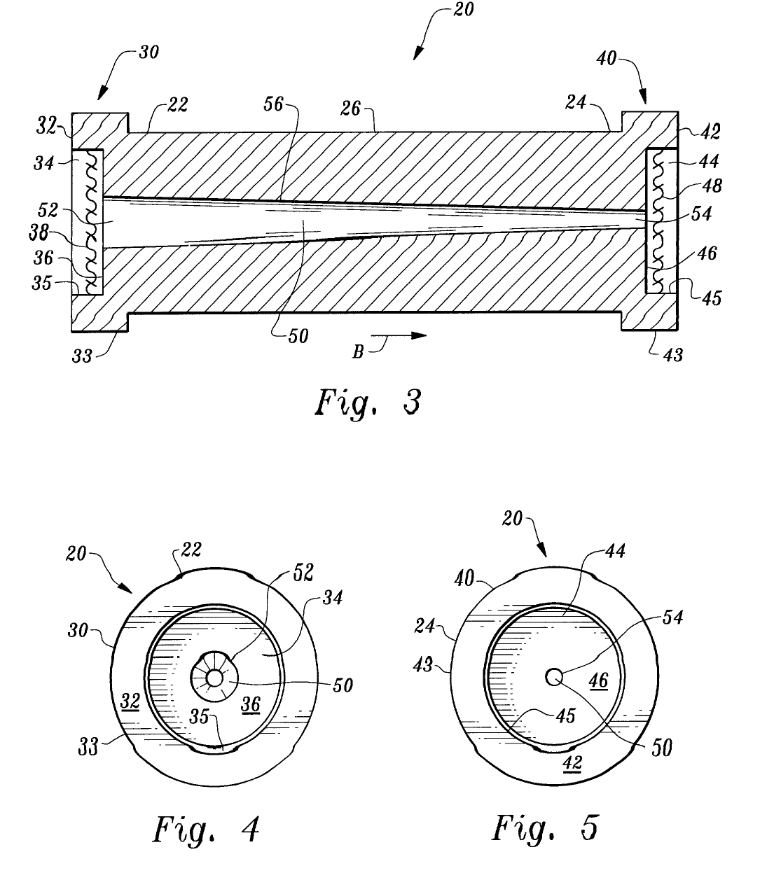

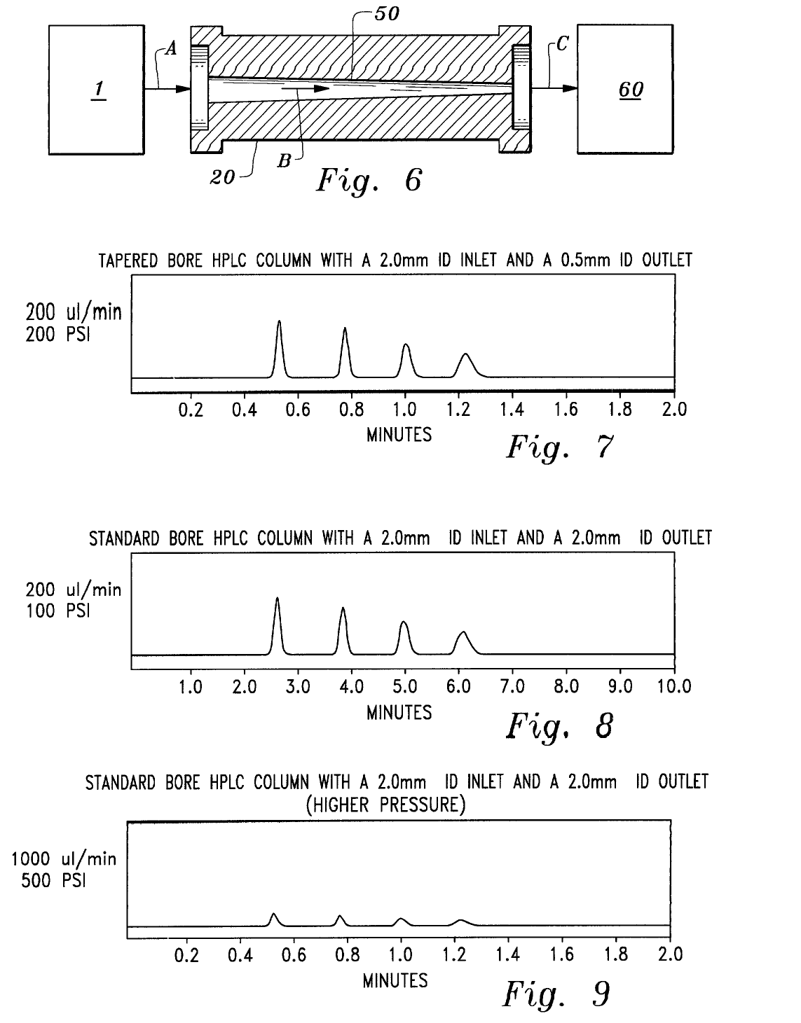

Referring to the drawings, wherein like reference numerals represent like parts throughout the various drawing figures, reference numeral 20 (FIGS. 2 and 3) is directed to a column for use within a holder 10 (FIG. 1) as part of an overall analytical high performance liquid chromatography (HPLC) system (FIG. 6). The column 20 has a tapering bore 50 passing therethrough in contrast to cylindrical bores passing through prior art columns. The tapering bore 50 allows the column 20 to more rapidly and more precisely separate components of a sample for later detection.

In essence, and with particular reference to FIG. 3, the primary structural features of the column 20 of this invention are described. The column 20 is an elongate cylindrical structure which has a tapering bore 50 passing therethrough. An inlet ring 30 surrounds a first end 22 of the column 20. The inlet ring 30 supports an inlet frit 38 overlying an inlet 52 of the tapering bore 50. An outlet ring 40 is located adjacent a second end 24 of the column 20 and supports an outlet frit 48 adjacent an outlet 54 of the tapering bore 50. While the tapering bore 50 can have various different configurations, the tapering bore 50 is preferably frusto-conical in form with a side wall 56 which tapers at a constant rate from the inlet 52 to the outlet 54. The inlet 52 is thus larger in cross-sectional area than the outlet 54.

More particularly, and with particular reference to FIG. 1, details of the holder 10 are described. Preferably, the column 20 is not placed directly into a HPLC device/system. Rather, the column 20 is first inserted into a holder 10. The holder 10 with column 20 therein is then inserted into the HPLC system. The system typically additionally includes a sample injector 1 (FIG. 6) upstream from the column 20 and a detector 60 downstream from the column 20. If necessary, the holder 10 can take on various different configurations to properly adapt to the dimensional requirements of a variety of different HPLC systems. The preferred holder 10 includes a supply manifold 12 which supports an inlet conduit 13 passing therethrough and is surrounded by a collar 14 (FIG. 1). An outlet manifold 16, supporting a discharge conduit 17 therein, threadably engages the collar 14 with the column 20 between the outlet manifold 16 and the collar 14.

In this way, the column 20 is securely supported within the holder 10 with the first end 22 of the column 20 directly adjacent the inlet conduit 13 of the supply manifold 12 and the second end 24 of the column 20 directly adjacent the discharge conduit 17 of the outlet manifold 16. If necessary, the holder 10 can additionally assist the column 20 in withstanding forces associated with high pressure within the tapering bore 50 within the column 20. While not shown in FIG. 1, the column 20 would typically have an inlet frit 38 (FIG. 3) and an outlet frit 48 appropriately inserted to maintain a chromatographic separation medium packed within the tapering bore 50 of the column 20.

With particular reference to FIGS. 2-5, details of the column 20 are described. The column 20 is preferably formed from a rigid mass of material in a unitary fashion with a generally cylindrical shape having the tapering bore 50 passing along a central axis of the column 20. Preferably, the column 20 is formed by injection molding from a polymeric hydrocarbon material having the ability to withstand pressures up to 5,000 psi and which is highly non-reactive with a variety of different materials which might be present as components within samples passed through the column 20. Most preferably, the column 20 is formed from a poly ether ether ketone material.

The column 20 preferably has a cylindrical outer wall 26 extending between a first end 22 and a second end 24. The first end 22 supports an inlet ring 30 integrally formed with the first end 22. The second end 24 includes an outlet ring 40 integrally formed with the second end 24 of the column 20.

The inlet ring 30 is dimensioned to bear against portions of the holder 10 both radially and axially to properly position the column 20 where desired within the holder 10. Specifically, the inlet ring 30 includes an inlet rim 32 which is flat and defines the axial extremity of the first end 22 of the column 20. An outside wall 33 defines a radial extremity of the outlet ring 40. The outlet wall 43 is preferably cylindrical and extends further from the central axis of the column 20 than the outer wall 26. A frit recess 34 extends in from the inlet rim 32. An inside wall 35 defines a perimeter of the inlet frit recess 34. A face 36 of circular form is surrounded by the inside wall 35.

The inside wall 35 is preferably substantially cylindrical but actually slightly tapering. This slight taper allows an inlet frit 38 to be press fitted into the inlet frit recess 34 with an interference fit between the inlet frit 38 and the inside wall 35. The inlet frit 38 is preferably formed from titanium and has fenestrations therein which are smaller than a particle size of the chromatographic separation medium packed within the tapering bore 50 of the column 20. The inlet frit 38 thus helps maintain the separation medium within the bore 50.

The outlet ring 40 is substantially similar in form to the inlet ring 30. Hence, the outlet ring 40 includes an outlet rim 42, outside wall 43, outlet frit recess 44, inside wall 45 and face 46. An outlet frit 48 of similar construction to the inlet frit 38 is press fitted into the outlet frit recess 44. The outlet frit 48 thus assists in holding the separation medium within the tapering bore 50 of the column 20. Typically, the inlet frit 38, outlet frit 48 and separation medium are not considered part of the column 20. Rather, when the column 20 is packed with the separation medium and the frits 38, 48 are press fitted in place, the assembly of column 20, inlet frit 38, outlet frit 48 and separation medium are referred to as a cartridge. This packed cartridge is then placed into the holder 10 for eventual use within a HPLC system.

The tapering bore 50 extends entirely from the first end 28 of the column 20 to the second end 24 of the column 20. The tapering bore 50 includes an inlet 52 adjacent the first end 22 and an outlet 54 adjacent the second end 24. A side wall 56 extends between the inlet 52 and the outlet 54. The side wall 56 is preferably frusto-conical in form having a constant rate of taper between the inlet 52 and the outlet 54. The inlet 52 thus maintains a larger diameter than the outlet 54.

The particular dimensions for the inlet 52, outlet 54 and rate of taper of the side wall 56 can be varied depending on the particular needs of the user. In at least one application it has been shown to be effective to provide an inlet 52 of circular cross-section with a 2.0 millimeter diameter and an outlet 54 with a circular cross-section of 0.5 millimeter diameter, and with a side wall 56 which tapers at a constant rate between the inlet 52 and the outlet 54 on a column approximately 1.0 inches long. Alternatives for the configuration of the tapering bore 50 include allowing the side wall 56 to taper in steps between the inlet 52 and the outlet 54, or to have an accelerating or decelerating rate of taper, such that a greater or lesser slope away from a central axis of the bore 50 is exhibited closer to the inlet 52 or the outlet 54.

With particular reference to FIG. 6, details are described of the system in which the tapered bore column 20 of this invention can be utilized. A typical HPLC system utilized for sample analysis includes a sample injector 1 located upstream from the column 20. The sample is directed, along arrow A, to the inlet 52 of the column 20. The sample then passes through the tapered bore 50 of the column 20, along arrow B where the sample is separated into its components by an appropriate separation medium packed into the tapering bore 50. The components of the sample are then sequentially discharged out of the outlet 54 of the tapering bore 50 and are passed onto the detector 60, along arrow C. The detector 60 can be any of a variety of different devices including an ultraviolet spectrophotometer, a mass spectrometer or other device capable of determining either mere presence of the components of the sample, the identity or characteristics of the components of the sample, and/or the specific quantity of one or more sample components. This information can then be used in accordance with the needs of the user, such as to verify the purity of the sample being analyzed.

The particular efficacy of the tapered bore column 20 of this invention is particularly illustrated by consideration of the following examples. In conventional HPLC the separation of the sample components (resolution) is a function of the column length, linear velocity of the mobile phase (optimum at ˜5 cm/min, independent of the ID for conventional tubular columns), temperature, column packing particle diameter and selectivity of the column packing stationary phase. Simple samples (1-10 different sample components of similar polarity) are usually separated in 5-30 minutes on columns from 50-300 mm long, packed with particles from 3-10 microns in diameter using a mobile phase of constant composition (isocratic elution). More complex samples (10-100+ different sample components of widely varying polarity) often require separation time of 30-300+ minutes using a continuously changing mobile phase (gradient elution) from polar to non-polar solvents in reversed phase HPLC.

To illustrate the particular efficacy of this invention, a sample containing four distinct components, (methyl, ethyl, propyl and butyl paraben), was analyzed in a HPLC system (Magic 2002 HPLC, Michrom BioResources, Inc., Auburn, Calif.) including the tapered bore column 20 of this invention. A flow rate of 200 micro liters per minute and a pressure of 200 psi were utilized. The sample was completely analyzed after 1.3 minutes with an appropriately high level of resolution and sensitivity.

In a second experiment (FIG. 8) the same sample was utilized in the same HPLC system but with a standard bore HPLC column utilized rather than the tapered bore column 20 of this invention. The column had a 2.0 millimeter inner diameter along its length which matched the inlet inner diameter of the tapered bore column 20 utilized in the first example (FIG. 7). The same flow rate of 200 micro liters per minute was utilized with a pressure of 100 psi only being necessary to push the sample through the standard bore HPLC column. A similar level of separation resolution and sensitivity was obtained as that provided by the tapered bore column 20, but required over six minutes to complete. Hence, an approximately five-fold increase in time was required to analyze the sample with a similar degree of resolution and sensitivity when utilizing a standard cylindrical bore HPLC column.

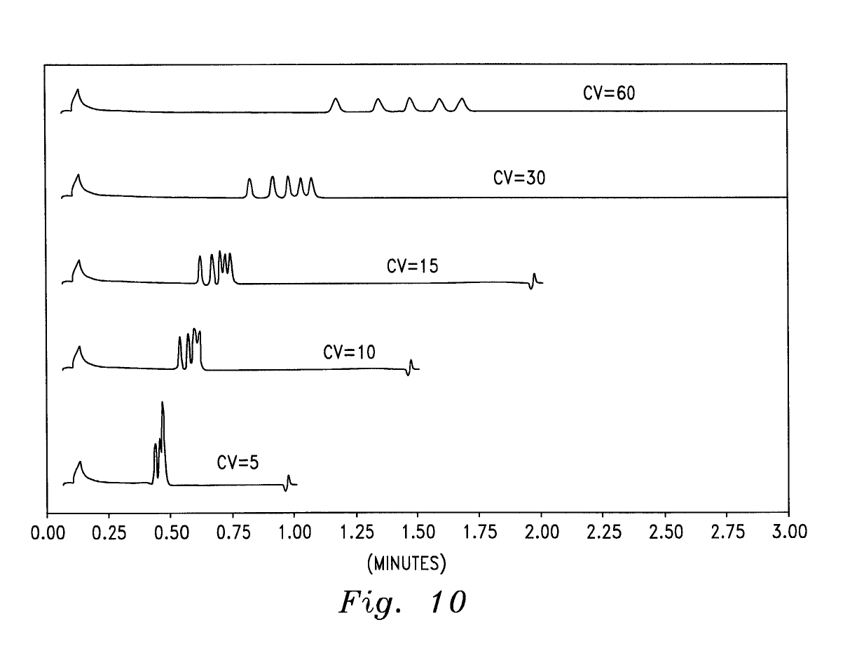

With reference to FIG. 9, a different approach to high speed chromatographic separation of sample components utilizing a standard bore HPLC column was compared to the results obtained with the tapered bore column 20 of this invention. Specifically, the same sample was utilized in the same HPLC system, but the flow rate was raised to 1,000 micro liters per minute and the pressure raised to 500 psi. The sample was fully analyzed after 1.3 minutes just as when utilizing the tapered bore column of this invention. However, the sensitivity obtained in this higher pressure higher flow rate standard bore HPLC column example was significantly degraded. Accordingly, the test data depicted in FIGS. 7-9 show that the tapered bore column 20 of this invention provides either higher sensitivity in a similar amount of time at lower flow rates and lower pressure or higher speed with similar sensitivity when compared to standard bore HPLC columns. In either case, an advantage of approximately five times was evidenced.

Another technique for maximizing the speed of analytical HPLC, especially when the sample contains many components (i.e. ten or more) involves utilizing a gradient elution HPLC process. In gradient elution HPLC, resolution is usually improved (at the cost of time) by increasing the time it takes to go from the polar starting solvent to the non-polar final solvent. This improvement in resolution is due to the fact the column bed volume is changed more times during a long gradient than during a short gradient. This concept is shown in FIG. 10, where the number of column volumes (CV) per minute is increased from 5 to 60, and the resulting resolution and peak capacity (the total number of component peaks that can be separated over the gradient time) improve in direct proportion to the number of column volumes displaced during the gradient.

When the data is generated using a conventional cylindrical bore HPLC column with a 2.0 mm ID and a 25 mm length, running at a flow rate of 1,000 ml per minute (a linear velocity of 25 cm per minute or five times the optimum linear velocity). Optimum resolution is achieved in the 30-60 CV/min range, but using a short, conventional cylindrical bore column (constant ID at five times the standard flow velocity), this level of resolution requires gradient times of 3-6 minutes, and total analysis times of 5-10 minutes.

Because of the tapered bore of the column 20 of this invention, the total column bed volume is only 20% of the volume of a conventional HPLC column of the same length with a constant ID equal to the inlet ID of the column 20 of this invention (i.e. 2.0 mm). At the same flow rate as the conventional HPLC column (1,000 ml/min), the column 20 of this invention would displace 30-60 CV in 36-72 seconds (FIG. 10), resulting in total analysis times between 1-2 minutes, a five-fold improvement.

In addition to the improvements in resolution per unit time gained using the column 20 of this invention due to its lower column volume, the tapering bore 50 also helps to improve resolution by axially concentrating the individual sample component bands as they traverse the length of the column 20. This axial compression results in narrower sample peaks at the outlet 54 of the bore 50, further improving resolution and peak capacity for complex separations. In effect, the sample component concentration at the outlet 54 of the bore 50 is sixteen times greater than at the inlet 52 (due to a four time reduction in ID from the inlet 52 the outlet 54). Although the same concentration could theoretically be achieved using a conventional HPLC column with an ID equal to the ID at the outlet 54 of the bore 50 (i.e. 0.5 mm), the pressure required to run such a column at the same flow rate (i.e. 1,000 ml/min) would be prohibitively high (much greater than the 5,000 psi upper pressure limit of most HPLC columns and systems).

A third advantage of the tapered bore design of the column 20 of this invention for complex samples is that the total sample loading capacity is equal to that of a conventional column with a constant ID equal to the inlet ID of the column 20 of this invention. This is especially important for quantitative assays of pharmaceutical compounds and their metabolites in physiological fluids. In order to achieve the high throughput and high sensitivity required by these quantitative assays (in vitro metabolism studies, pharmacokinetic studies, etc.), large volumes of sample are injected onto the HPLC column. Although decreasing the column ID will result in better sensitivity for single component standards, this is not true for physiological fluid assays because the volume of sample injected must be proportional to the ID of the column to prevent overloading and rapid destruction of the column. Using the column 20 of this invention, the sample capacity at the inlet 52 is the same as for a conventional HPLC column of the same ID, but as the components in the sample are separated during the gradient elution process, the individual amount of each component is much less than the total and therefore the capacity at the outlet 54 (1/16 the area of the inlet 52) is sufficient to prevent overloading by the separated individual sample components.

This disclosure is provided to reveal a preferred embodiment of the invention and a best mode for practicing the invention. Having thus described the invention in this way, it should be apparent that various different modifications can be made to the preferred embodiment without departing from the scope and spirit of this disclosure. When structures are identified as a means to perform a function, the identification is intended to include all structures which can perform the function specified.

What is claimed is:

1. A column for use in an analytical high performance liquid chromatography apparatus to rapidly and precisely separate components of a sample for later identification downstream from the column, the column comprising in combination:
a first end spaced from a second end;
a bore extending from an inlet at said first end to an outlet at said second end; and
said inlet of said bore having a greater cross-sectional size than a cross-sectional size of said outlet of said bore.

2. The column of claim 1 wherein said bore includes a side wall which at least partially tapers on at least a portion of said bore between said first end and said second end.

3. The column of claim 2 wherein said side wall tapers continuously from said inlet of said bore to said outlet of said bore.

4. The column of claim 3 wherein said inlet is circular in cross-section and side wall tapers at a constant rate of taper from said inlet of said bore to said outlet of said bore, such that said side wall of said bore is frusto-conical.

5. The column of claim 2 wherein said inlet has a width at least twice as large as a width of said outlet of said bore.

6. The column of claim 5 wherein said side wall of said bore tapers continuously from said inlet to said outlet at a constant rate of taper, said inlet having a circular cross-section with a diameter at least as small as 5.0 millimeters, said outlet having a circular cross-section with a diameter at least as small as 2.5 millimeters.

7. The column of claim 6 wherein said column is constructed of an injection molded poly ether ether ketone material.

8. The column of claim 7 wherein said column is configured to withstand a pressure of up to at least 5,000 psi.

9. The column of claim 8 wherein said column is formed from a material sufficiently strong so that said bore can withstand pressures of up to at least 5,000 psi without failure.

10. A high pressure liquid chromatography column comprising in combination:
a mass of solid material;
a bore passing through said mass from an inlet to an outlet; and
said bore having a side wall which is at least partially tapered at at least one location between said inlet and said outlet in a manner constricting flow of fluids traveling away from said inlet and toward said outlet.

11. The chromatography column of claim 10 wherein said bore includes a separation medium packed into said bore with at least one frit located adjacent said outlet of said bore, said frit having fenestrations smaller than said separation medium elements, such that said frit keeps said separation medium within said bore.

12. The chromatography column of claim 11 wherein said inlet of said bore has a greater cross-sectional area than said outlet of said bore.

13. The chromatography column of claim 12 wherein said side wall of said bore has a frusto-conical contour which tapers constantly from said inlet to said outlet.

14. The chromatography column of claim 13 wherein said inlet of said bore is located at a first end of said column surrounded by a ring having a greater diameter than portions of said column between said first end and a second end of said column, said ring including an inlet frit press fitted into an inlet frit recess overlying said inlet of said bore.

15. A chromatography system for rapid analysis of components within a liquid sample, the system comprising in combination:
a liquid sample supply manifold having an inlet conduit;
a column having a first end opposite a second end and a bore passing through said column from said first end to said second end;
said bore having a side wall which is at least partially tapered at at least one location between said inlet and said outlet in a manner constricting flow of fluids traveling away from said inlet and toward said outlet;
a chromatography medium packed into said bore;
an outlet manifold having a discharge conduit; and
means to evaluate the components of the sample separated by said chromatography medium within said bore.

16. The system of claim 15 wherein said bore of said column includes said side wall tapering at a constant rate of taper from said inlet of said bore to said outlet of said bore.

17. The system of claim 16 wherein said bore of said column has a circular cross-section with a diameter of said inlet greater than a diameter of said outlet.

18. The system of claim 17 wherein said diameter of said inlet is at least twice as large as said diameter of said outlet.

19. The system of claim 18 wherein said liquid sample supply manifold delivers said sample into said bore at a pressure of up to at least 5,000 psi.

20. The system of claim 19 wherein said liquid sample supply manifold delivers a sample at flow rates of between 50 and 1,000 micro liters per minute.
